(19) United States
(12) Patent Application Publication
(10) Pub. No.: US 2006/0193523 A1
(43) Pub. Date: Aug. 31, 2006

(54) Repetition coded compression for highly correlated image data

(75) Inventor: Arvind Thiagarajan, Chennai (IN)

Correspondence Address: SEED INTELLECTUAL PROPERTY LAW GROUP PLLC, 701 FIFTH AVE, SUITE 6300, SEATTLE, WA, 98104-7092, US

(73) Assignee: Matrixview Limited, Singapore (SG)

(21) Appl. No.: 11/354,585

(22) Filed: Feb. 14, 2006

Related U.S. Application Data
(63) Continuation-in-part of application No. 10/511,235, filed on Feb. 16, 2006.

(30) Foreign Application Priority Data
Apr. 1, 2002 (IN) 895/MAS/2001

(51) Int. Cl. G06K 9/36

(52) U.S. Cl. 382/232

(57) ABSTRACT

A process and a system for compressing highly correlated image data is provided. The system comprises means for capturing the image, means for converting to digital form, means for reshaping the data, means for encoding the repetitions, means for storing the compressed data and means for retrieving the data. The method comprises steps like capturing the image, converting into digital form, reshaping the data into matrix form, encoding the repetitions into a bit-plane index and encoding data values for storage, storing the compressed data in memory and retrieving the data for decompression. The system and method for compressing image and other highly correlated data is described in the description and illustrated by the way of drawings.

### FIELD OF THE INVENTION

The present invention relates to a method and system of compressing image data and other highly correlated data streams.

### BACKGROUND OF INVENTION

Image and data compression is of vital importance and has great significance in many practical applications. To choose between lossy compression and lossless compression depends primarily on the application.

Some applications require a perfectly lossless compression scheme so as to achieve zero errors in the automated analysis. This is particularly relevant when where an automatic analysis is performed on the image or data. Generally, Huffman coding and other source coding techniques are used to achieve lossless compression of image data.

In certain other applications, the human eye visually analyzes images. Since the human eye is insensitive to certain patterns in the images, such patterns are discarded from the original images so as to yield good compression of data. These schemes are termed as “visually lossless” compression schemes. This is not a perfectly reversible process as the de-compressed image data is different from the original image data. The degree of difference depends on the quality of compression, and the compression ratio. Compression schemes based on discrete cosine transforms and wavelet transforms followed by lossy quantization of data are typical examples of visually lossless scheme.

As a general rule, it is desirable to achieve the maximum compression ratio with zero, or minimal, possible loss in the quality of the image. At the same time, the complexity involved in the system and the power consumed by the image compression system are important parameters when it comes to a hardware-based implementation.

Usually, image compression is carried out in two steps. The first step is to use a pre-coding technique, which is normally based on signal transformations. The second step would be to further compress the data values by standard source coding techniques such as, for example, Huffman and Lempel-Ziv schemes.

The initial pre-coding step is the most critical and important operation in image compression. The complexity involved with DCT and Wavelet based transformations is quite high because of the large number of multiplications involved. This is illustrated in the following DCT equation:

$$DCT ( i , j ) = \frac{1}{\sqrt{2 N}} C ( i ) C ( j ) {\sum }_{x = 0}^{N - 1} {\sum }_{y = 0}^{N - 1} f ( x , y ) cos ⌈ \frac{( 2 x + 1 ) i π}{2 N} ⌉ cos ⌈ \frac{( 2 y + 1 ) j π}{2 N} ⌉$$

$$where C ( x ) = \frac{1}{\sqrt{2}} if x = 0 , else 1 if x > 0.$$

In addition to the large number of multiplications involved in carrying out the above DCT equation, there is also a zigzag rearrangement of the image data, which involves additional complexity. These conventional schemes for image compression are not very well suited for hardware-based implementation.

The true requirement is an image compression system which does not involve rigorous transforms, and complex calculations. It also has to be memory efficient and power efficient.

There are various image compression techniques presently available. A familiar few are JPEG, JPEG-LS, JPEG-2000, CALIC, FRACTAL and RLE.

JPEG compression is a trade-off between degree of compression, resultant image quality, and time required for compression/decompression. Blockiness results at high image compression ratios. It produces poor image quality when compressing text or images containing sharp edges or lines. Gibb's effect is the name given to this phenomenon—where disturbances/ripples may be seen at the margins of objects with sharp borders. It is not suitable for 2-bit black and white images. It is not resolution independent, and does not provide for scalability, where the image is displayed optimally depending on the resolution of the viewing device.

JPEG-LS does not provide support for scalability, error resilience or any such functionality. Blockiness still exist at higher compression ratios and it does not offer any particular support for error resilience, besides restart markers.

JPEG-2000 does not provide any truly substantial improvement in compression efficiency and is significantly more complex than JPEG, with the exception of JPEG-LS for lossless compression. The complexity involved in JPEG-2000 is higher for a lower enhancement in the compression ration and efficiency.

Although CALIC provides the best performance in lossless compression, it cannot be used for progressive image transmission as it implements a predictive-based algorithm that can work only in lossless/nearly-lossless mode. Complexity and computational cost are high.

The results show that the choice of the “best” standard depends strongly on the application at hand.

### BRIEF DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings in which:

FIG. 1 illustrates the entire image compression system based on repetition coded compression on a hardware implementation;

FIG. 2 is a sample grayscale image of a human brain, which is captured by magnetic resonance imaging (“MRI”) to demonstrate the compression able to be achieved by repetition coded compression system;

FIG. 3 is an enlarged image of a small region from FIG. 2;

FIG. 4 shows that the image of FIG. 2 is made up of many pixels in grayscale;

FIG. 5 shows a 36-pixel region within the sample MRI image of FIG. 2;

FIG. 6 shows the ASCII value equivalent of the image data values for the image of FIG. 2;

FIG. 7 shows the application of repetition coded compression along the horizontal direction in the image matrix;

FIG. 8 shows the application of repetition coded compression along the vertical direction in the image matrix;

FIG. 9 shows the combination of horizontal and vertical bit-planes by a binary addition operation;

FIG. 10 shows the total memory required for the 36-pixel region before and after applying repetition coded compression;

FIG. 11 shows the application of repetition coded compression to the entire image; and

FIG. 12 shows the operational flow for the implementation of repetition coded compression.

### DETAILED DESCRIPTION

In accordance with a preferred aspect there is provided a method of compression of image data of an image wherein each element is compared with a previous element. If they are both equal, a first value is recorded. If they are not both equal, a second value is recorded. Each element may be a pixel. The first value may be a 1, and the second value may be a 0.

The first and second values may be stored in a bit plane. For a one-dimensional compression, a single bit plane may be used to store the values. However, for a two-dimensional compression, comparison may be in both horizontal and vertical directions, a separate bit plane being used for each direction.

The bit-planes for the horizontal and vertical directions may be combined by binary addition to for a repetition coded compression bit-plane. Combining may be by binary addition, only the second values being stored for lossless reconstruction of the image. The result of the combining may be repetition coded compression data values. All other image data values may be able to be reconstructed using the repetition coded compression data values, and the bit planes for the horizontal and vertical directions.

Storage in bit planes may be in a matrix. A single mathematical operation may be performed for each element.

In accordance with a further aspect, there is provided a system for repetition coded compression comprising a camera for capturing at least one image and for supplying digital data; a reshaping block for rearranging the digital data into a matrix of image data values; a processor for receiving the matrix of image data values and compressing the image data values to form compressed data; and a memory for storage of the compressed data.

The camera may be analog. An analog-to-digital converter may be used to convert the analog image to provide the digital data.

In accordance with another aspect, there is provided a method for compression of an image comprising capturing the image and converting the image into digital form to provide digital data. The digital data is reshaped into a digital data matrix. Repetitions in the digital data matrix are encoded into a bit-plane index, and the data values of the digital data matrix are encoded for storage. The compressed data is stored in a storage memory.

The bit-planes may contain information regarding the repetitions along horizontal and vertical directions. There may be further included the combining of the horizontal and vertical bit-planes by a binary addition operation to give a repetition coded compression bit-plane. There may also be included comparing the repetition coded compression bit-plane with the digital data matrix to obtain final repetition coded compression data values.

The method may further include storing and archiving the repetition coded compression data values along with the horizontal and vertical bit-planes.

The compression is preferably lossless. Alternatively, the method a method may further include compression by comparison with a threshold value to achieve lossy compression and a significantly higher compression ratio.

The method may be used for an application selected from: medical image archiving, medical image transmission, database system, information technology, entertainment, communications applications, and wireless application, satellite imaging, remote sensing, and military applications.

Image data is a highly correlated. This means that the adjacent data values in an image are repetitive in nature. Therefore, it is possible to achieve some compression out of this repetitive property of the image and then apply Huffman coding or other source coding schemes. Such a method would be very efficient.

In repetition coded compression (“RCC”), each element is compared with the previous element. If both of them are equal then a value of “1” is stored in a bit-plane. Otherwise a value of ‘0’ is stored in the bit-plane. Only the difference value is stored in a matrix, instead of storing all the repeating values.

In a one-dimensional performance of the method, only one bit-plane is used to code the repetition in the horizontal direction.

But in a two-dimensional performance of the method, two bit-planes are used to code the repetitions in both the horizontal and the vertical directions. This is more efficient and gives a better compression ratio.

The compression system is based on a mathematical comparison of adjacent image data values. The comparison is performed between adjacent image data values in both the horizontal as well as vertical directions. The bit-planes formed as a result of the comparison in the horizontal and vertical directions are respectively combined by a binary addition method. After this the resultant bit-plane positions are called as RCC bit-planes. The zero values in the RCC bit-plane are stored for lossless reconstruction of the original image. For lossless reconstruction, they are the only values stored. The stored values correspond to the same locations in the original image matrix as zeros in the RCC bit-plane and are hereinafter called RCC data values. All the other image data values can be reconstructed by using the RCC data values, and the horizontal and vertical bit-planes.

In case of a lossy system of implementation, the adjacent pixels are not only compared for repetition, but also for the difference value. if the difference value between adjacent pixels is less than a given arbitrary threshold value, then the two adjacent pixels are made as the same. This further increases the number of repetitions in the image data and therefore also increases the compression ratio after repetition coded compression is applied. The value of the threshold can be varied according to the requirements of the particular application, and system. The higher the threshold, the better the compression ratio and also the higher the loss in the quality of the reconstructed image.

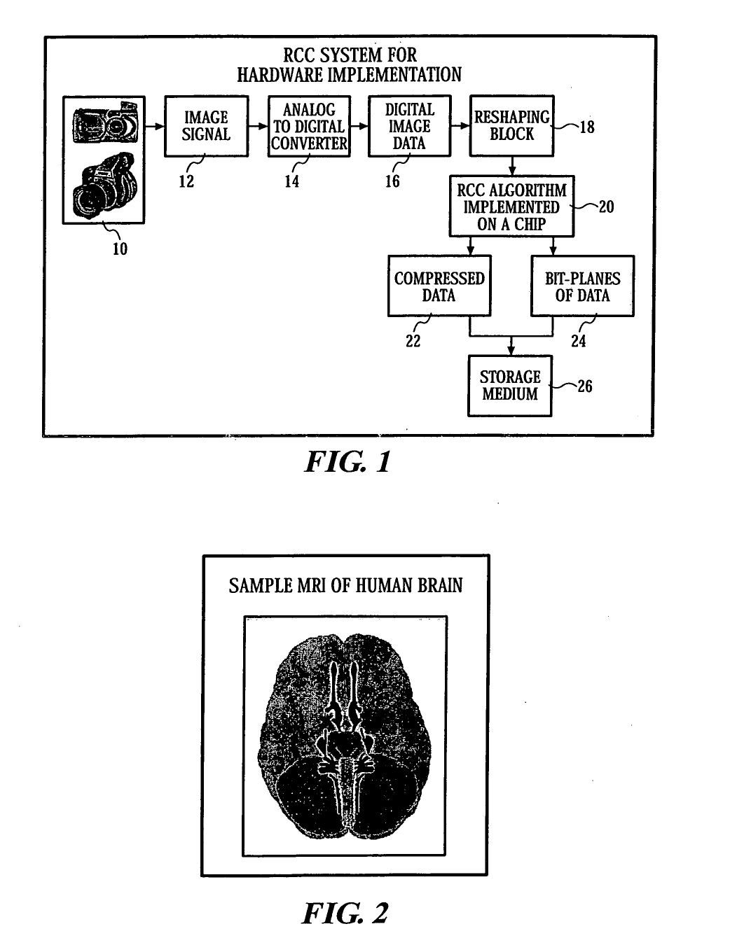

FIG. 1 illustrates the entire image compression system based on repetition coded compression on a hardware implementation. The analog image signals 12 are captured by the camera 10 and are converted into respective digital data 16 by a analog to digital converter 14. This digital data 16 is rearranged into a matrix of image data values by a reshaping block 18. The reshaped image matrix is stored in the embedded chip 20, which performs the entire repetition coded compression system. This therefore gives the compressed repetition coded compression data values 22 and also the bit-planes of data 24 for storage, archival and future retireval 26.

FIG. 2 is a sample image of the human brain which is captured by magnetic resonance imaging (MRI). This sample image may be used to demonstrate the compression achieved by repetition coded compression. It is a grayscale image.

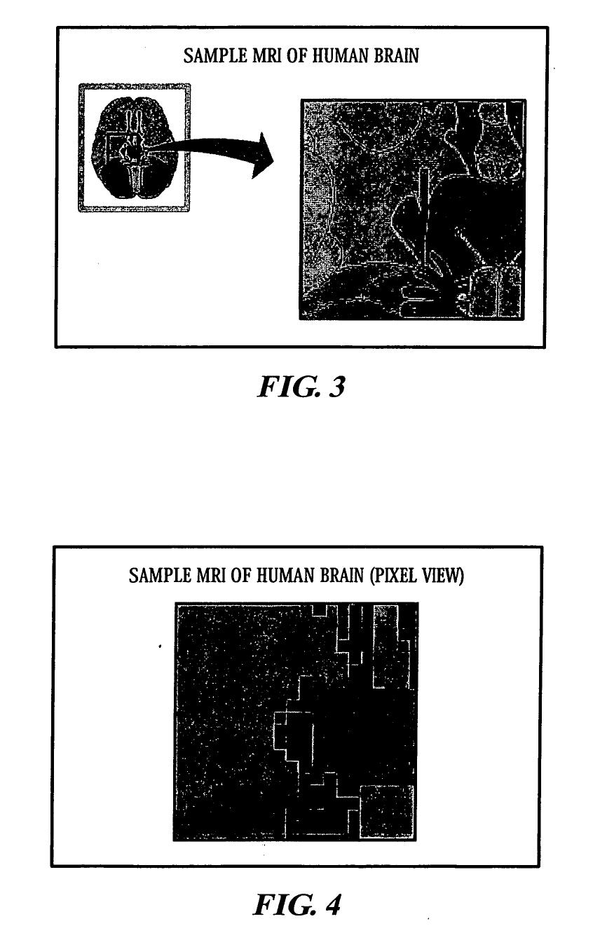

FIG. 3 zooms a small region from the sample MRI image of the human brain. This zoomed region may also be used for demonstrating the repetition coded compression system.

FIG. 4 shows that the image is made up of lot of pixels in grayscale.

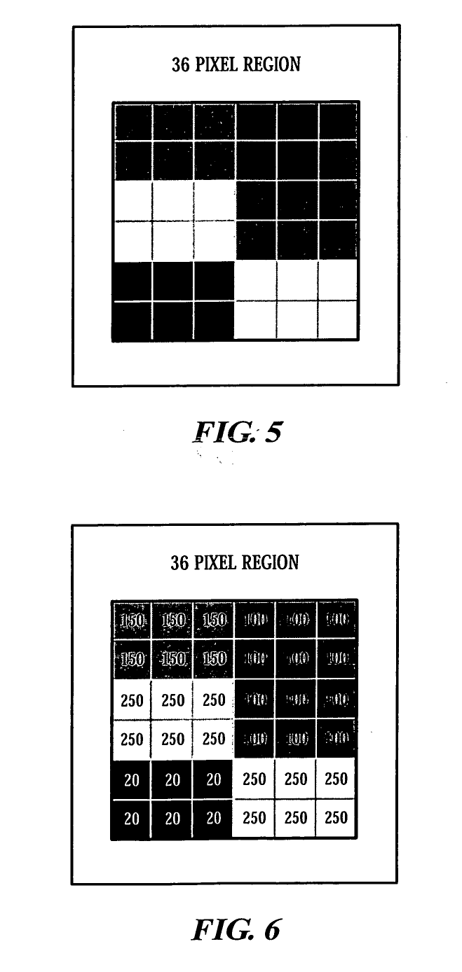

FIG. 5 shows a 36-pixel region within the sample MRI image of the human brain.

FIG. 6 shows the ASCII value equivalents of the image data values which are originally used for data storage. Each value requires eight bits (1 byte) of data memory. Currently, the 36-pixel region requires about 288 bits or 36 bytes of data memory. That data could be compressed and stored with only 112 bits after repetition coded compression.

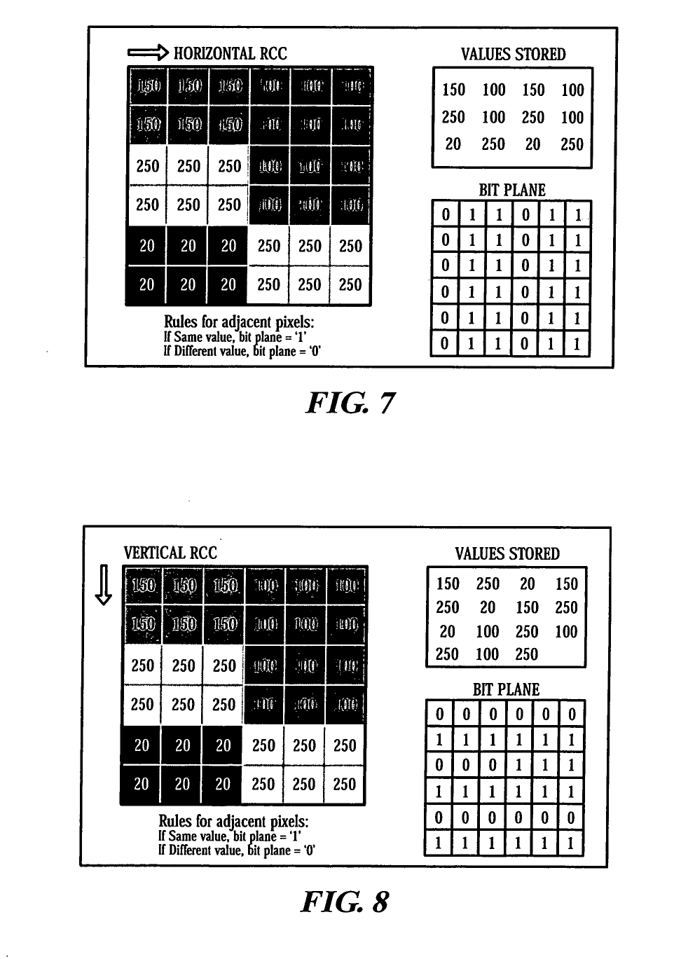

FIG. 7 shows the application of repetition coded compression along the horizontal direction in the image matrix. This results in the horizontal bit-plane and also the horizontal values stored.

FIG. 8 shows the application of repetition coded compression along the vertical direction in the image matrix. This result in the vertical bit-plane, and also the vertical values stored.

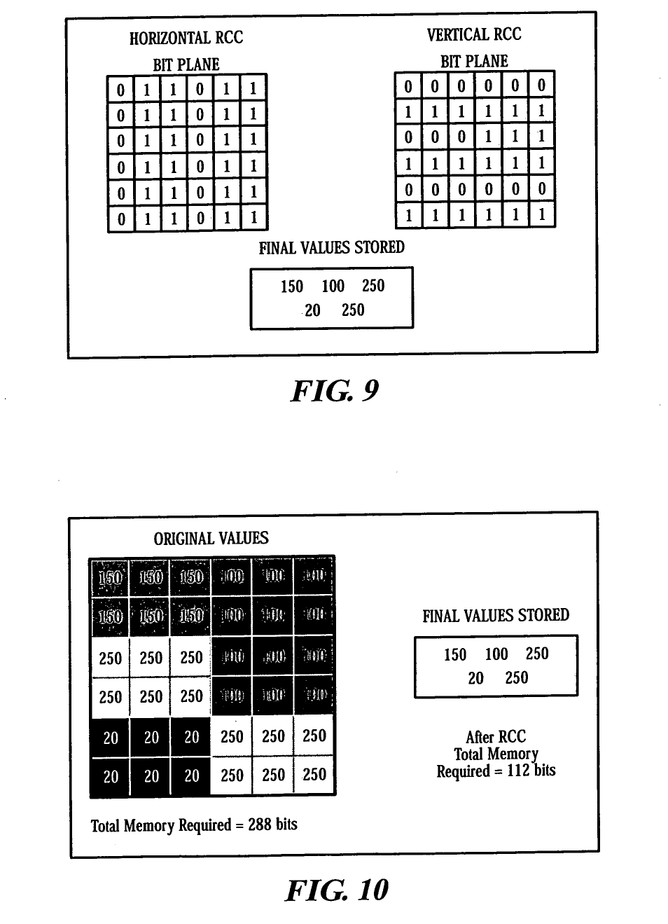

FIG. 9 shows the combination of horizontal and vertical bit-planes by a binary addition operation. This results in only five zero values which correspond to the final values stored from the original image matrix.

FIG. 10 shows the total memory required for the 36-pixel region before and after applying repetition coded compression. The original memory requirement was 288 bits. After applying repetition coded compression the memory required was 112 bits. This is a great amount of compression.

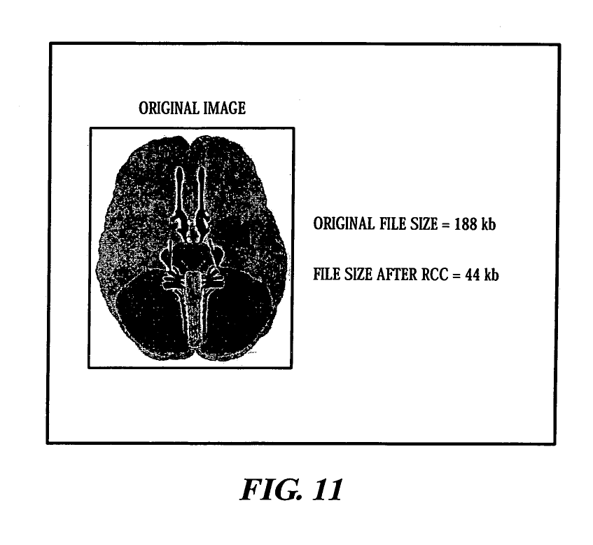

FIG. 11 shows the application of repetition coded compression to the entire image. The size is compressed to 44,000 bits from the original 188,000 bits.

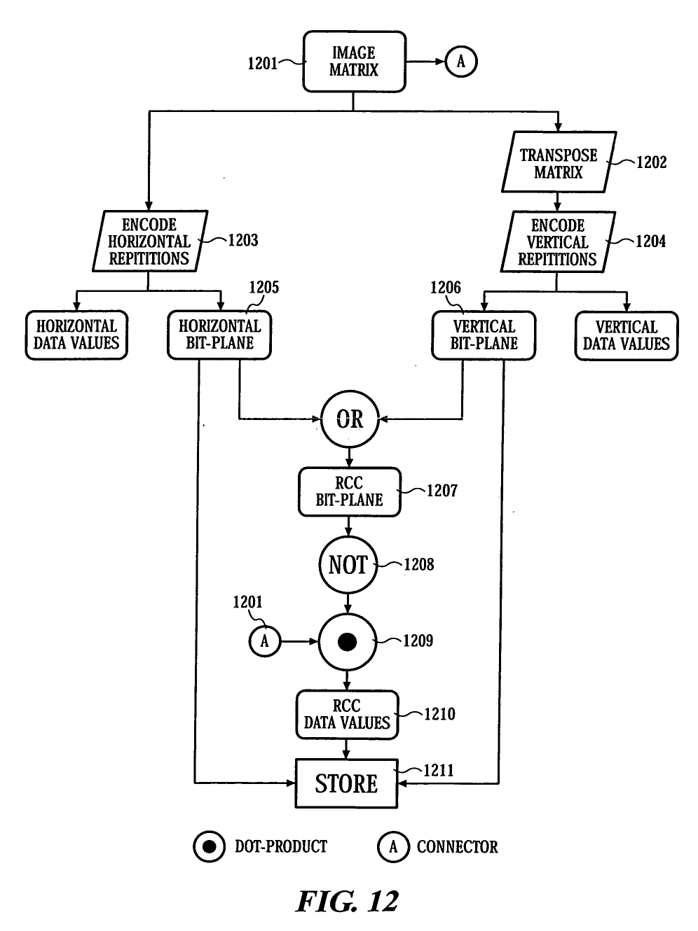

FIG. 12 shows an implementation of repetition coded compression. The image matrix 1201 is transposed 1202, encoded along the horizontal 1203 and vertical 1204 directions and the respective bit-planes 1205, 1206 are derived. Further compression is achieved by combining the horizontal and vertical bit-planes 1203, 1204 by a binary addition operation. This results in the repetition coded compression bit-plane 1207, which is logically inverted 1208 and compared 1209 with the original image matrix 1201 to obtain the final repetition coded compression data values 1210. The repetition coded compression data values 1210, together with the horizontal and vertical 1206 bit-planes are stored in a data memory 1211 for archival and future retrieval.

The coded data can be further compressed by Huffman coding. This compression of the image data is achieved using the repetition coded compression system. This system is fast as it does not make use of complex transform techniques. The method may be used for any type of image file. In the example given above, the system is applied only for grayscale images. It may be applied to color images.

The system of repetition coded compression of images may be applied to fields such as, for example, medical image archiving and transmission, database systems, information technology, entertainment, communications and wireless applications, satellite imaging, remote sensing, military applications.

The preferred embodiment of the present invention is based on a single mathematical operation and requires no multiplication for its implementation. This results in memory efficiency, power efficiency, and speed, in performing the compression. Because of the single mathematical operation involved, the system is reversible and lossless. This may be important for applications which demand zero loss. The compression ratios may be significantly higher than existing lossless compression schemes.

If the application permits a lossy compression system, a modification is made to the mathematical operation so that a certain amount of loss is observed in the compression, thereby resulting in higher compression ratios. This lossy compression system would find great applications in entertainment and telecommunication systems.

Whilst there has been described in the foregoing description a preferred embodiment of the present invention, it will be understood by those skilled in the technology that many variations or modifications in details of design, constructions or operation may be made without departing from the present invention.

1. A method for increasing compressibility of image data of an image wherein each element is compared with a previous element and:
(a) if they are both equal, a first value is recorded; and
(b) if they are not both equal, a second value is recorded.

2. A method as claimed in claim 1, wherein each element is a pixel.

3. A method as claimed in claim 1, wherein the first value is a 1, and the second value is a 0.

4. A method as claimed in claim 1, wherein the first and second values are stored in a bit plane.

5. A method as claimed in claim 4, wherein for a one-dimensional compression, a single bit plane is used to store the values.

6. A method as claimed in claim 4, wherein for a two-dimensional compression, comparison is in both horizontal and vertical directions, a separate bit plane being used for each direction.

7. A method as claimed in claim 6, wherein the bit-planes for the horizontal and vertical directions are combined by binary addition to form a repetition coded compression bit-plane.

8. A method as claimed in claim 7, wherein the combining is by binary addition, only the second values being stored for lossless reconstruction of the image.

9. A method as claimed in claim 8, wherein the result of the combining is repetition coded compression data values, all other image data values being able to be reconstructed using the repetition coded compression data values, and the bit planes for the horizontal and vertical directions.

10. A method as claimed in claim 4, wherein storage in bit planes is in a matrix.

11. A method as claimed in claim 4, further comprising encoding repetitions in the bit plane into a bit-plane index and encoding image data values of the image data, to form compressed data.

12. A method as claimed claim 1, wherein a single mathematical operation is performed for each element.

13. A system for compression of an image, the system comprising:
(a) a camera for capturing at least one image and for supplying digital data;
(b) a reshaping block for reshaping the digital data into a matrix of image data values;
(c) a processor for encoding repetitions in the matrix of image data values into a bit-plane index, and for encoding the image data values of the matrix, the encoded repetitions and image data values forming compressed data; and
(d) a memory for storage of the compressed data;
wherein each image data value is compared with a previous image data value and:
(i) if they are both equal, a first value is recorded; and
(ii) if they are not both equal, a second value is recorded.

14. A system as claimed in claim 13, wherein the camera is analog, the system further comprising an analog-to-digital converter to convert the analog image to supply the digital data.

15. A method for compression of an image, the method comprising:
(a) capturing the image;
(b) converting the image into digital form to provide digital data;
(c) reshaping the digital data into a digital data matrix of image data values;
(d) encoding repetitions in the digital data matrix into a bit-plane index, and encoding image data values of the digital data matrix to form compressed data; and
(e) storing the compressed data;
wherein each image data value is compared with a previous image data value and:
(i) if they are both equal, a first value is recorded; and
(ii) if they are not both equal, a second value is recorded.

16. A method as claimed in claim 15, wherein there the bit-planes containing information regarding the repetitions along horizontal and vertical directions.

17. A method as claimed in claim 16, wherein there is further included combining the horizontal and vertical bit-planes by a binary addition operation to give a repetition coded compression bit-plane.

18. A method as claimed in claim 17, further including comparing the repetition coded compression bit-plane with the digital data matrix to obtain final repetition coded compression data values.

19. A method as claimed in claim 18, further including storing and archiving the repetition coded compression data values along with the horizontal and vertical bit-planes.

20. A method as claimed in claim 15, wherein the compression is lossless.

21. A method as claimed in claim 15, further including compression by comparison with a threshold value to achieve lossy compression and a significantly higher compression ratio.

22. A method as claimed in claim 15, wherein the method is used for an application selected from the group consisting of: medical image archiving, medical image transmission, database system, information technology, entertainment, communications applications, and wireless application, satellite imaging, remote sensing, and military applications.

23. A computer readable memory medium stored with a program for increasing compressibility of image data of an image wherein each element is compared with a previous element and:
(a) if they are both equal, a first value is recorded; and
(b) if they are not both equal, a second value is recorded.

24. A computer readable memory medium stored with a program for compression of an image, said computer readable memory medium is further stored with a program for:
(a) capturing the image;
(b) converting the image into digital form to provide digital data;
(c) reshaping the digital data into a digital data matrix;
(d) encoding repetitions in the digital data matrix into a bit-plane index, and encoding image data values of the digital data matrix to form compressed data; and
(e) storing the compressed data;
wherein each image data value is compared with a previous image data value and:
(i) if they are both equal, a first value is recorded; and
(ii) if they are not both equal, a second value is recorded.
